(19) United States
(12) Patent Application Publication
(10) Pub. No.: US 2010/0097972 A1
(43) Pub. Date: Apr. 22, 2010

(54) Detection and Efficient Use of Broadcast-Only Modes of Cellular Communication System Operation

(76) Inventors: Stefan Parkvall, Stockholm (SE); Erik Dahlman, Bromma (SE)

Correspondence Address: POTOMAC PATENT GROUP PLLC, P. O. BOX 270, FREDERICKSBURG, VA, 22404, US

(21) Appl. No.: 12/523,657

(22) PCT Filed: Feb. 4, 2008
(86) PCT No.: PCT/SE08/50133

§ 371 Date: Jul. 17, 2009

(30) Foreign Application Priority Data
Feb. 13, 2007 (SE) 0700366-8

(51) Int. Cl. H04W 72/04; H04H 20/71

(52) U.S. Cl. 370/312; 370/329

(57) ABSTRACT

Operation of a network node in a mobile communication system that serves a User Equipment (UE) includes ascertaining whether the network node is operating in a broadcast-only mode. If so, then broadcast channel information is transmitted on a physical multicast/broadcast channel. Otherwise, the broadcast channel information is transmitted on a physical broadcast channel. To inform the UE of where to find the broadcast channel information, the network node transmits an indicator to the UE, wherein the indicator indicates whether the broadcast channel information is conveyed via the physical broadcast channel or the physical multicast/broadcast channel. The indicator can be included within signals that are also used to enable a UE's cell search procedure.

### BACKGROUND

The present invention relates to methods and arrangements in a telecommunication system, and more particularly to methods and arrangements for detecting and efficiently using broadcast-only modes of operation of a cellular communication system.

In the forthcoming evolution of the mobile cellular standards like the Global System for Mobile Communication (GSM) and Wideband Code Division Multiple Access (WCDMA), new transmission techniques like Orthogonal Frequency Division Multiplexing (OFDM) are likely to occur. Furthermore, in order to have a smooth migration from the existing cellular systems to the new high-capacity high-data rate system in existing radio spectrum, a new system has to be able to utilize a bandwidth of varying size. Such a new flexible cellular system, called Third Generation Long Term Evolution (LTE), can be seen as an evolution of the 3G WCDMA standard. This system will use OFDM as the multiple access technique (called OFDMA) in the downlink and will be able to operate on bandwidths ranging from 1.25 MHz to 20 MHz. Furthermore, data rates up to and exceeding 100 Mb/s will be supported for the largest bandwidth. However, it is expected that LTE will be used not only for high rate services, but also for low rate services like voice. Since LTE is designed for Transmission Control Protocol/Internet Protocol (TCP/IP), Voice over IP (VoIP) will likely be the service that carries speech.

Transmissions from the system that are targeted to be received by a single user take place in what is termed a “unicast” mode of operation. Here, there is a single transmitter that communicates information to a single intended receiver. The LTE system is, however, additionally designed to support broadcast/multicast services, called Multimedia Broadcast/Multicast Service (MBMS). In conventional approaches, the concurrent provision of both unicast and broadcast/multicast capabilities results in a number of inefficiencies, as will be explored in the following.

The provisioning of broadcast/multicast services in a mobile communication system allows the same information to be simultaneously provided to multiple, often a large number of, mobile terminals, often dispersed over a large area corresponding to a large number of cells. FIG. 1 illustrates this point by showing a broadcast area 101 that comprises a number of cells 103. The broadcast/multicast information may be a TV news clip, information about the local weather conditions, stock-market information, or any other kind of information that, at a given time instant, may be of interest to a large number of users.

When the same information is to be provided to multiple mobile terminals within a cell it is often beneficial to provide this information as a single “broadcast” radio transmission covering the entire cell and simultaneously being received by all relevant mobile terminals rather than providing the information by means of individual transmissions to each mobile terminal (i.e., plural unicast transmissions).

As a broadcast transmission within a cell has to be dimensioned to operate under worst-case conditions (e.g., it needs to be able to mobile terminals at the cell border even though other mobile terminals may be quite close to the transmitter antenna), it can be relatively costly in terms of the resources (base station transmit power) needed to provide a given broadcast-service data rate. Alternatively, taking into account the limited signal-to-noise ratio that can be achieved at poor areas of reception within the cell (e.g. the cell edge), the achievable broadcast data rates may be relatively limited, especially when large cells are involved. One way to increase the broadcast data rates would then be to reduce the cell size, thereby increasing the power of the received signal at the cell's edge. However, such an approach would increase the number of cells needed to cover a certain area and would thus obviously be undesirable from a cost-of-deployment point-of-view.

However, as discussed above, the provisioning of broadcast/multicast services in a mobile communication network typically occurs when identical information is to be provided over a large number of cells. In such cases, the resources (e.g., base-station transmit power) needed to provide a desired broadcast data rate can be considerably reduced if, when detecting/decoding the broadcast data, mobile terminals at the cell edge can utilize the received power from multiple broadcast transmissions emanating from multiple cells.

One way to achieve this is to ensure that the broadcast transmissions from different cells are truly identical and transmitted mutually time-aligned. Under these conditions, the transmissions received by user equipment (UE) (e.g., a mobile terminal) from multiple cells will appear as a single transmission subject to severe multi-path propagation. The transmission of identical time-aligned signals from multiple cells, especially when utilized to provide broadcast/multicast services, is sometimes referred to as Single-Frequency-Network (SFN) operation or Multicast-Broadcast Single Frequency Network (MBSFN) operation.

When multiple cells transmit such identical time-aligned signals, the UE no longer experiences “inter-cell interference” from its neighbor cells, but instead experiences signal corruption due to time dispersion. If the broadcast transmission is based on OFDM with a cyclic prefix that covers the main part of this “time dispersion”, the achievable broadcast data rates are thus only limited by noise, implying that, especially in smaller cells, very high broadcast data rates can be achieved. Furthermore, the OFDM receiver does not need to explicitly identify the cells to be soft combined. Rather, all cells whose transmissions fall within the cyclic prefix, will “automatically” be contribute to the power of the UE's received signal.

The processing associated with implementing most modern communication systems is structured into different protocol layers. WCDMA/High-Speed Packet Access (WCDMA/HSPA) and LTE systems are just two of a number of examples. A general overview of the LTE protocol architecture for the downlink is illustrated in FIG. 2. As will become clear in the subsequent discussion, not all the entities illustrated in FIG. 2 are applicable in all situations. For example, neither Medium Access Control (MAC) scheduling, nor hybrid Automatic Repeat Request (ARQ) with soft combining, is used for broadcast of system information.

Data to be transmitted in the downlink enters in the form of IP packets on one of the SAE bearers. Prior to transmission over the air, incoming IP packets are passed through multiple protocol entities, summarized below and described in more detail in the following sections.
Packet Data Convergence Protocol (PDCP) performs Internet Protocol (IP) header compression.
Radio Link Control (RLC) offers services to the PDCP in the form of radio bearers.
Medium Access Control (MAC) offers services to the RLC in the form of logical channels.
Physical Layer (PHY) handles coding/decoding, modulation/demodulation, multi-antenna mapping, and other typical physical layer functions. The physical layer offers services to the MAC layer in the form of transport channels.

The MAC offers services to the RLC layer via so-called logical channels. A logical channel is defined by the type of information transmitted. Logical channel types that are relevant to this discussion are summarized in the following:
Broadcast Control Channel (BCCH), used for transmission of system control information from the network to all mobile terminals in a cell. Prior to accessing the system, a UE needs to read the information transmitted on the BCCH to find out how the system is configured (e.g., to learn what resources are to be used for random access).
Dedicated Traffic Channel (DTCH), used for transmission of user data to/from a UE. This is the logical channel type used for transmission of uplink and downlink unicast data.
Multicast Traffic Channel (MTCH), used for downlink transmission of MBMS services. An MCCH logical channel is used to carry MTCH-specific control information.

The physical layer offers services to the MAC layer in the form of Transport Channels. A transport channel is defined by how and with what characteristics the information is to be transmitted over the air. Transport channels that are relevant to this discussion include:
Broadcast Channel (BCH), which has a fixed transport format, provided by the specifications. It is used for transmission of the information on the BCCH logical channel. MBSFN is not supported.
Downlink Shared Channel (DL-SCH). This is the transport channel used for transmission of (unicast) downlink data in an LTE system. MBSFN operation is not supported.
Multicast Channel (MCH), which is used to support MBMS. The MCH supports MBSFN operation.

Part of the MAC functionality is multiplexing of different logical channels and mapping of the logical channels to the appropriate transport channels. As there is some relation between the type of information and the way it should be transmitted, there are certain restrictions on the mapping of logical channels to transport channels. An example of mapping of logical channels to transport channels is given in FIG. 3. Specifically, in the downlink direction only, the BCCH logical channel is mapped to the BCH transport channel, while the MTCH logical channel is mapped to the MCH transport channel. Additionally, in either of the Downlink or Uplink directions, the DTCH logical channel is mapped to the DL-SCH (downlink) or UL-SCH (uplink).

The LTE physical layer downlink transmission is based on OFDM. The basic LTE downlink physical resource can thus be seen as a time-frequency grid as illustrated in FIG. 4, in which each so-called “resource element” corresponds to one OFDM subcarrier during one OFDM symbol interval.

As illustrated in FIG. 5, the downlink subcarriers in the frequency domain are grouped into resource blocks, where each resource block consists of twelve consecutive subcarriers for a duration of one 0.5 ms slot (7 OFDM symbols when normal cyclic prefixes are used (as illustrated) or 6 OFDM symbols when extended cyclic prefixes are used), corresponding to a nominal resource-block bandwidth of 180 kHz.

The total number of downlink subcarriers, including a DC-subcarrier, thus equals Nᵤ=12·N_{RB}+1 where N_{RB} is the maximum number of resource blocks that can be formed from the 12·N_{RB} usable subcarriers. The LTE physical-layer specification actually allows for a downlink carrier to consist of any number of resource blocks, ranging from N_{RB-min}=6 and upwards, corresponding to a nominal transmission bandwidth ranging from around 1 MHz up to well beyond 20 MHz. This allows for a very high degree of LTE bandwidth/spectrum flexibility, at least from a physical-layer-specification point-of-view.

FIGS. 6a and 6b illustrate the time-domain structure for LTE downlink transmission. Each 1 ms sub-frame 600 consists of two slots of length Tₛₗₒₜ=0.5 ms (=15360·T_{S}, wherein each slot comprises 15,360 time units, T_{S}). Each slot then consists of a number of OFDM symbols.

A subcarrier spacing Δf=15 kHz corresponds to a useful symbol time Tᵤ=1/Δf≈66.7 μs (2048·T_{S}). The overall OFDM symbol time is then the sum of the useful symbol time and the cyclic prefix length T_{CP}. Two cyclic prefix lengths are defined. FIG. 6a illustrates a normal cyclic prefix length, which allows seven OFDM symbols per slot to be communicated. The length of a normal cyclic prefix, T_{CP}, is 160·T_{S}≈5.1 μs for the first OFDM symbol of the slot, and 144·T_{S}≈4.7 μs for the remaining OFDM symbols.

FIG. 6b illustrates an extended cyclic prefix, which because of its longer size, allows only six OFDM symbols per slot to be communicated. The length of an extended cyclic prefix, T_{CP-e}, is 512·T_{S}≈16.7 μs.

It will be observed that, in the case of the normal cyclic prefix, the cyclic prefix length for the first OFDM symbol of a slot is somewhat larger than those for the remaining OFDM symbols. The reason for this is simply to fill out the entire 0.5 ms slot, as the number of time units per slot, T_{S}, (15360) is not evenly divisible by seven.

When the downlink time-domain structure of a resource block is taken into account (i.e., the use of 12 subcarriers during a 0.5 ms slot), it will be seen that each resource block consists of 12·7=84 resource elements for the case of normal cyclic prefix (illustrated in FIGS. 5), and 12·6=72 resource elements for the case of the extended cyclic prefix (not shown).

Another important aspect of a terminal's operation is cell search. Cell search is the procedure by which the terminal finds a cell to which it can potentially connect. As part of the cell search procedure, the terminal obtains the identity of the cell and estimates the frame timing of the identified cell. The cell search procedure also provides estimates of parameters essential for reception of system information on the broadcast channel, containing the remaining parameters required for accessing the system.

To avoid complicated cell planning, the number of physical layer cell identities should be sufficiently large. For example, systems in accordance with the LTE standards support 504 different cell identities. These 504 different cell identities are divided into 168 groups of three identities each.

In order to reduce the cell-search complexity, cell search for LTE is typically done in several steps that make up a process that is similar to the three-step cell-search procedure of WCDMA. To assist the terminal in this procedure, LTE provides a primary synchronization signal and a secondary synchronization signal on the downlink. This is illustrated in FIG. 7, which illustrates the structure of the radio interface of an LTE system. The physical layer of an LTE system includes a generic radio frame 700 having a duration of 10 ms. FIG. 7 illustrates one such frame 700 for an LTE Frequency Division Duplex (FDD) system. Each frame has 20 slots (numbered 0 through 19), each slot having a duration of 0.5 ms which normally consists of seven OFDM symbols. A sub-frame is made up of two adjacent slots, and therefore has a duration of 1 ms, normally consisting of 14 OFDM symbols. The primary and secondary synchronization signals are specific sequences, inserted into the last two OFDM symbols in the first slot of each of subframes 0 and 5. In addition to the synchronization signals, part of the operation of the cell search procedure also exploits reference signals that are transmitted at known locations in the transmitted signal.

In the first step of the cell-search procedure, the mobile terminal uses the primary synchronization signal to find the timing of the 5 ms slots. Note that the primary synchronization signal is transmitted twice in each frame. One reason for this is to simplify handover of a call from, for example, a GSM system, to an LTE system. However, transmitting the primary synchronization signal twice per frame creates an ambiguity in that it is not possible to know whether the detected Primary Synchronization Signal is associated with slot #0 or slot #5 (see FIG. 7). Accordingly, at this point of the cell-search procedure, there is a 5 ms ambiguity regarding the frame timing.

In many cases, the timing in multiple cells is synchronized such that the frame start in neighboring cells coincides in time. One reason for this is to enable MBSFN operation. However, synchronous operation of neighboring cells also results in the transmission of the primary synchronization signals in the different cells occurring at the same time. Channel estimation based on the primary synchronization signal will therefore reflect the composite channel from all such cells if the same primary synchronization signal is used in those cells. For coherent demodulation of the second synchronization signal, which is different in different cells, an estimate of the channel from the cell of interest is required, not an estimate of the composite channel from all cells. Therefore, LTE systems support multiple sequences for the primary synchronization signals. To enable coherent reception of a particular cell's signals in a deployment with time-synchronized cells, neighboring cells are permitted to use different primary synchronization sequences to alleviate the channel estimation problem described above. If there is a one-to-one mapping between the primary synchronization signal used in a cell and the identity within a cell identity group, the identity within the cell identity group can also be determined in the first step.

In the next step, the terminal detects the cell identity group and determines the frame timing. This is done by observing pairs of slots in which the secondary synchronization signal is transmitted. To distinguish between Secondary Synchronization Signals located in subframe #0 and subframe #5, the Secondary Synchronization Signals are constructed in the form (s1, s2). If (s1, s2) is an allowable pair of sequences, where s1 and s2 represent the secondary synchronization signal in subframes #0 and #5, respectively, the reverse pair (s2, s1) is not a valid sequence pair. By exploiting this property, the terminal can resolve the 5 ms timing ambiguity that resulted from the first step in the cell search procedure, and determine the frame timing. Furthermore, as each combination (s1, s2) represents a particular one of the cell groups, the cell group identity is also obtained from the second cell search step.

Once the cell search procedure is complete, the terminal receives the system information to obtain the remaining parameters (e.g., the transmission bandwidth used in the cell) necessary to communicate with this cell. This broadcast information is transmitted on the BCH transport channel.

It has been observed to be a problem that, although the system described above does exploit the gains from SFN operation for the MBMS services transmitted on the MCH, it does not provide any SFN gains for the BCH. In systems providing both unicast services on the DL-SCH and broadcast services on the MCH, this is not a problem because parts of the BCH information are cell-specific and hence need to be provided individually per cell on the BCH. However, the situation is different for systems that are used only for broadcast transmissions (i.e., systems in which there is no unicast user data transmission on the DL-SCH). In such systems, there is no cell-specific information to be transmitted to the terminals. Rather, there is system-specific information that is the same regardless of which cell the terminal is located in, but this system-specific information is still mapped to the BCH, which is an inefficient way of disseminating this information.

It is therefore desired to provide methods and apparatuses that provide improved performance with respect to the problems identified above.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods and apparatuses that operate a network node in a mobile communication system that serves a User Equipment (UE). Such operation involves ascertaining whether the network node is operating in a broadcast-only mode. If so, then broadcast channel information is transmitted on a physical multicast/broadcast transmission resource. Otherwise, the broadcast channel information is transmitted on a physical unicast transmission resource. This enables transmission of the broadcast channel information to take advantage of any SFN gain that may be available.

In some embodiments, the physical multicast/broadcast transmission resource is a physical multicast/broadcast channel (MCH), and the physical unicast transmission resource is a physical broadcast channel (BCH).

To facilitate the UE's determining the location of the broadcast channel information, in another aspect of embodiments consistent with the invention, an indicator is transmitted to the UE, wherein the indicator indicates whether the broadcast channel information is conveyed via the physical unicast transmission resource or the physical multicast/broadcast transmission resource.

Other aspects involve methods and apparatuses for operating a User Equipment (UE) in a cellular communication system that includes a network node. Such operation involves receiving, from the network node, an indicator that indicates whether broadcast channel information is conveyed via a physical unicast transmission resource or a physical multicast/broadcast transmission resource. This indicator is used to ascertain whether broadcast channel information is conveyed via the physical unicast transmission resource or the physical multicast/broadcast transmission resource. The UE then receives the broadcast channel information from the physical unicast transmission resource (e.g., a physical broadcast channel (BCH)) if the indicator indicates that the broadcast channel information is conveyed via the physical unicast transmission resource, or receives the broadcast channel information from the physical multicast/broadcast transmission resource (e.g., a physical multicast/broadcast channel (MCH)) if the indicator indicates that the broadcast channel information is conveyed via the physical multicast/broadcast transmission resource.

In some embodiments, the indicator is a signal communicated to the UE from the network node at one or more predetermined locations within a radio frame for communicating at least one of timing and other information to the UE.

For example, the indicator can be a Primary Synchronization Signal (P-SyS) that enables the UE to determine a first timing parameter of signals received from the network node, the Primary Synchronization Signal (P-SyS) additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

In alternative embodiments, the indicator is a Secondary Synchronization Signal (S-SyS) that enables the UE to determine a second timing parameter of signals received from the network node, the Secondary Synchronization Signal (S-SyS) additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource. In some but not necessarily all of such embodiments, the at least one of the different sequences further indicates cell group information.

In yet other alternative embodiments, the indicator is a reference signal that enables the UE to determine cell specific information from the network node, the reference signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

### BRIEF DESCRIPTION OF THE DRAWINGS

The objects and advantages of the invention will be understood by reading the following detailed description in conjunction with the drawings in which:

FIG. 1 illustrates a broadcast area that comprises a number of geographically neighboring cells 103.

FIG. 2 is a high level block diagram depicting an exemplary LTE protocol layer architecture for the downlink.

FIG. 3 is a block diagram depicting a typical mapping of logical channels to transport channels in a communication system such as the LTE system.

FIG. 4 depicts a time-frequency grid illustrating a basic LTE downlink physical resource, in which each so-called “resource element” corresponds to one OFDM subcarrier during one OFDM symbol interval.

FIG. 5 illustrates how, in the frequency domain, the downlink subcarriers are grouped into resource blocks.

FIGS. 6a and 6b illustrate the time-domain structure for LTE downlink transmission with normal and extended cyclic prefixes, respectively.

FIG. 7 is signal timing diagram that illustrates the structure of the radio interface of an LTE system.

FIG. 8 is a flowchart depicting steps/processes carried out in a network-side component of a mobile communication system in accordance with an aspect of the invention.

FIG. 9 is a schematic diagram showing exemplary mappings of logical channels to physical channels in accordance with an aspect of the invention.

FIG. 10 is a flowchart depicting steps/processes carried out in a UE for detecting whether the BCCH is mapped to the BCH or to the MCH, in accordance with an aspect of the invention.

FIG. 11 is a flowchart depicting steps/processes carried out in a UE for using a received Primary Synchronization Signal to determine whether the BCCH is mapped to the BCH or to the MCH, in accordance with an aspect of the invention.

FIG. 12 is a flowchart depicting steps/processes carried out in a UE for using a received Secondary Synchronization Signal to determine whether the BCCH is mapped to the BCH or to the MCH, in accordance with an aspect of the invention.

FIG. 13 is a time-frequency grid illustrating reference signals that are used in unicast operation in an exemplary LTE communication system.

FIG. 14 is a time-frequency grid illustrating the overall structure of MBSFN sub-frames in LTE, including the overall reference symbol structure.

FIG. 15 is a flowchart depicting steps/processes carried out in a UE for using received reference signals to determine whether the BCCH is mapped to the BCH or to the MCH, in accordance with an aspect of the invention.

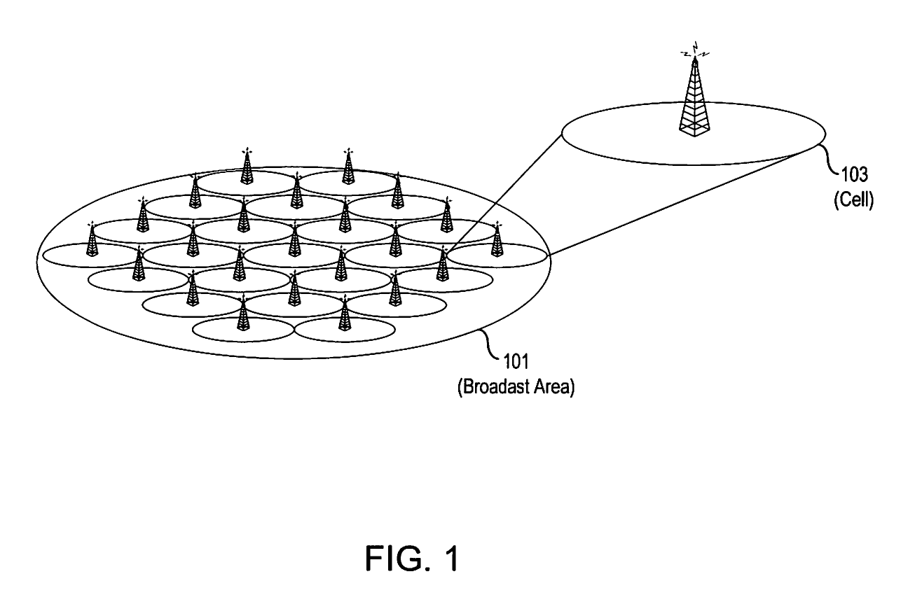

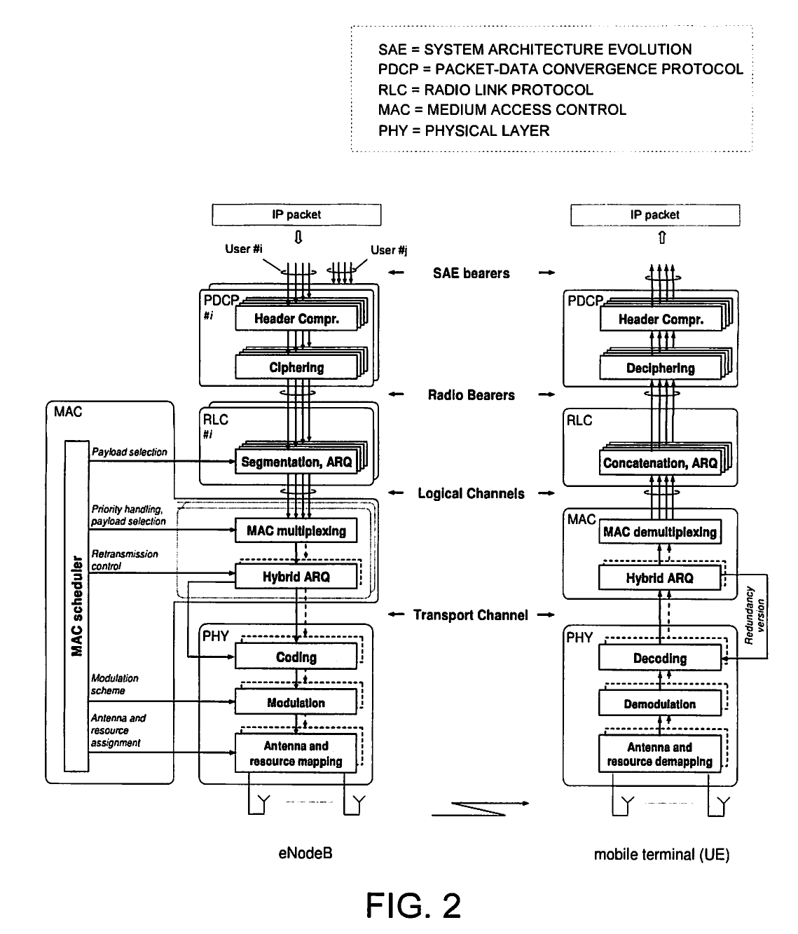

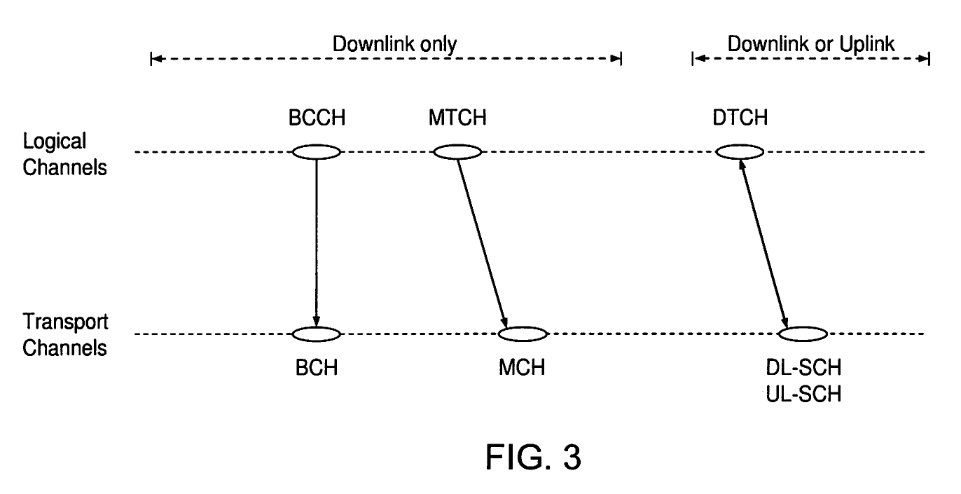

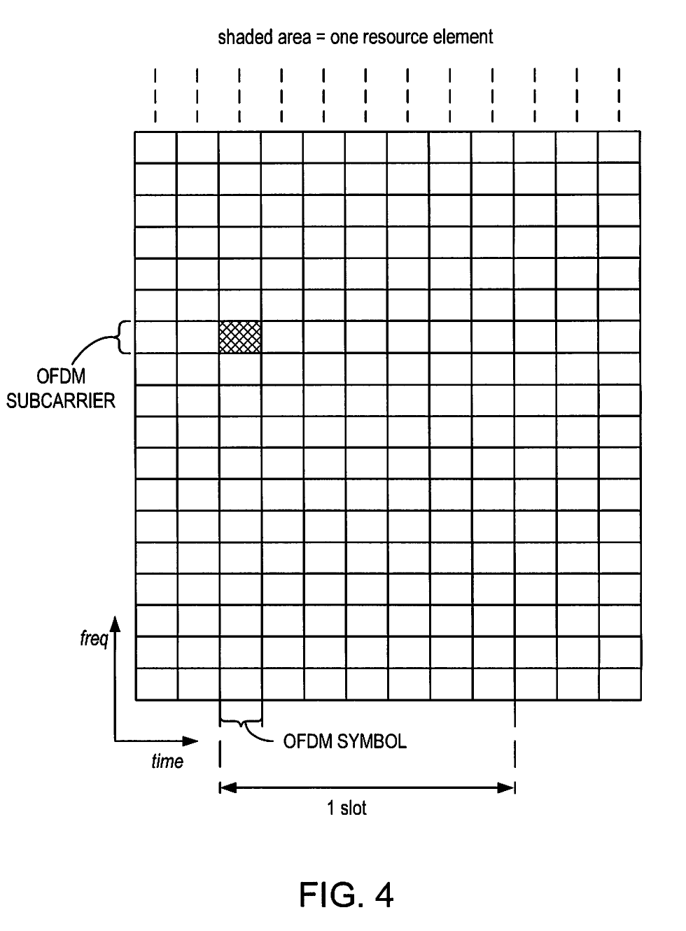

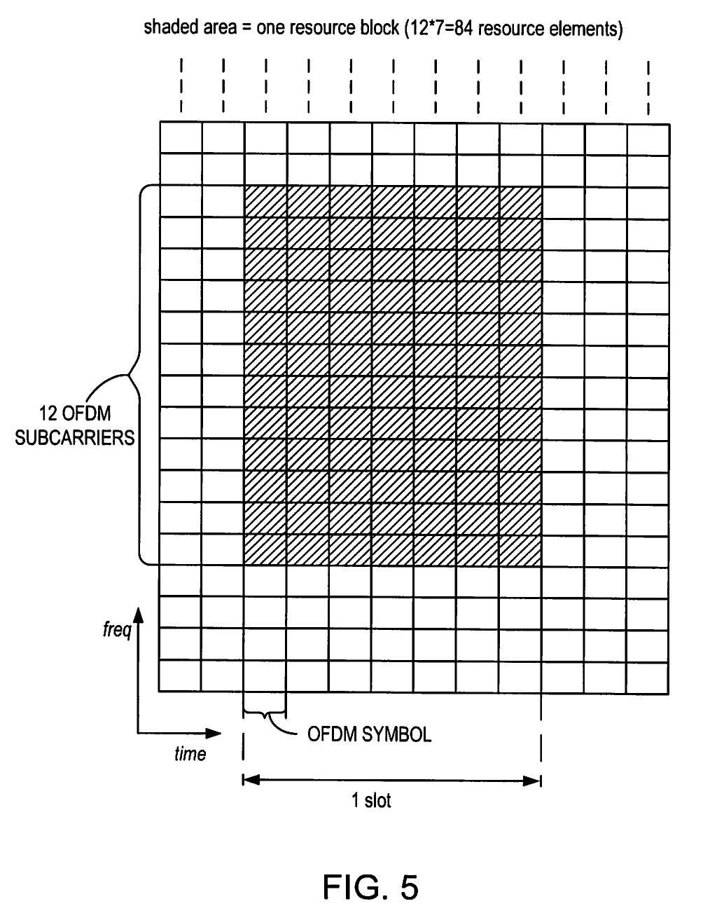

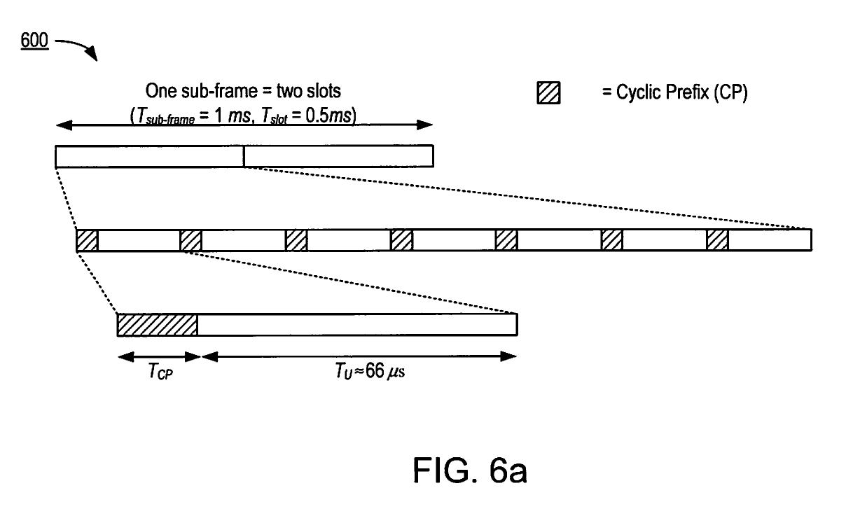

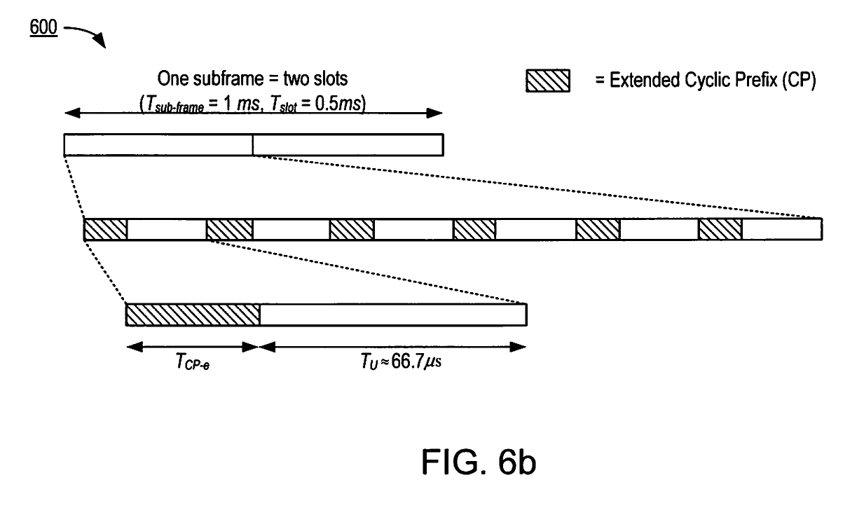

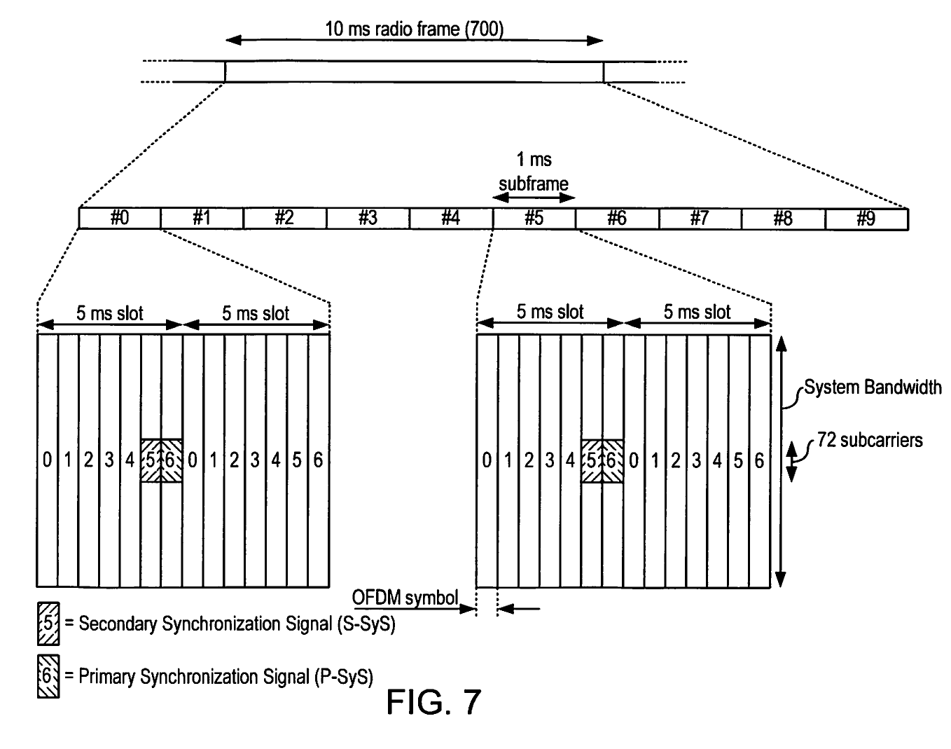

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action or function, or alternatively as “logic that” performs a described action or function.

As mentioned earlier, it has been observed to be a problem that, although the system described in the Background does exploit the gains from SFN operation for the MBMS services transmitted on the MCH, it does not provide any SFN gains for the BCH. In systems providing both unicast services on the DL-SCH and broadcast services on the MCH, this is not a problem because parts of the BCH information are cell-specific and hence need to be provided individually per cell on the BCH. However, the situation is different for systems that are used only for broadcast transmissions (i.e., systems in which there is no unicast user data transmission on the DL-SCH). In such systems, there is no cell-specific information to be transmitted to the terminals. Rather, there is system-specific information that is the same regardless of which cell the terminal is located in, but this system-specific information is still mapped to the BCH, which is an inefficient way of disseminating this information.

Therefore, in accordance with an aspect of embodiments consistent with the invention, system performance is improved by determining whether a system (e.g., a cell operating in a cellular communication system) is engaged only in broadcast transmissions, and if so, then mapping the system information (e.g., the BCCH) to a physical multicast/broadcast resource (e.g., in LTE the MCH) instead of to a physical unicast resource (e.g., in LTE the BCH). This enables the system to benefit from the SFN gain when disseminating the system information.

Information about whether the cell is operating in a broadcast-only mode is readily available to network components, making the determination of operating mode fairly straightforward at the transmitter side. However, the situation is not the same for a UE (e.g., mobile terminal) because conventional cell search procedures do not provide information that indicates whether the system is a broadcast-only network or a network providing both broadcast and unicast services. Therefore, in conventional deployments the system information on the BCCH logical channel still needs to be mapped to the physical unicast resource (e.g., the BCH transport channel) regardless of whether the system is engaged only in broadcast transmissions because doing otherwise would prevent the UE from being able to access the system.

Thus, in accordance with other aspects of embodiments consistent with the invention, methods and apparatuses are provided that enable a UE to determine, from the cell search procedure, whether the system is engaged only in broadcast transmissions. If so, then the UE obtains the BCCH logic channel information (e.g., system-specific information) from the physical multicast/broadcast resource (e.g., MCH). These and other aspects are described further in the following. Throughout the description, figures and claims, LTE terminology and concepts are used to facilitate the reader's understanding of the principles set forth herein. However, this is intended to provide non-limiting examples, so that references to BCH should be more generally understood to represent transmissions using a cell-specific transmission scheme, and references to MCH should be more generally understood to represent transmissions using MBSFN resources.

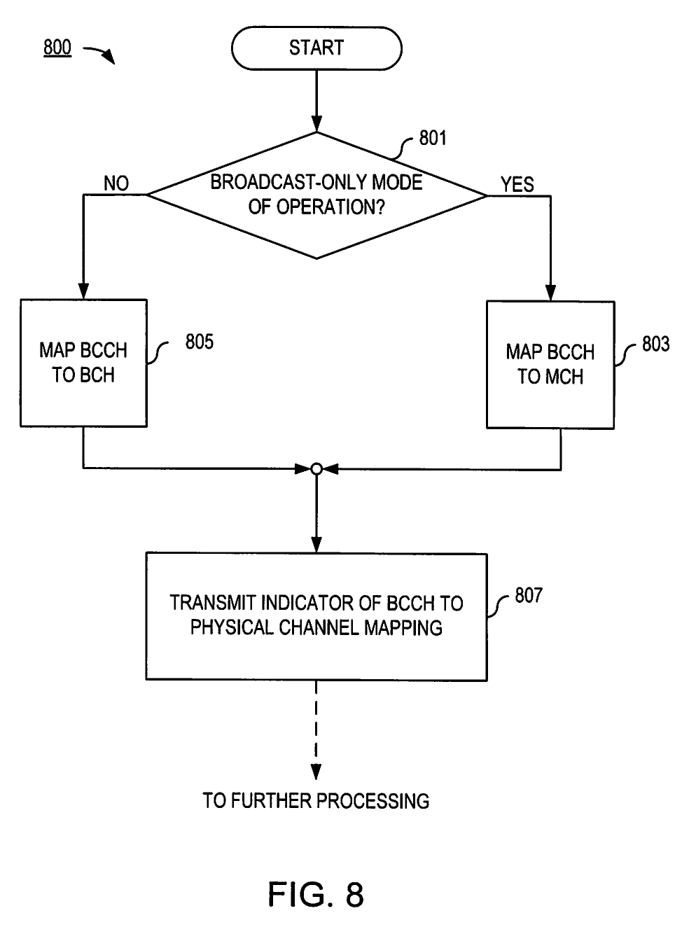

FIG. 8 is a flowchart depicting steps/processes carried out in a network-side component (e.g., a network node) of a mobile communication system. FIG. 8 can also be considered to illustrate logic within the network node 800 configured to perform the indicated functions.

A determination is made whether the network (e.g., cell) is operating in a broadcast-only mode (decision block 801). If so (“YES” path out of decision block 801), the BCCH (logical channel) is mapped to the MCH (physical channel) (step 803).

If the network is not operating in a broadcast-only mode (“NO” path out of decision block 801), the BCCH is mapped to the BCH (step 805).

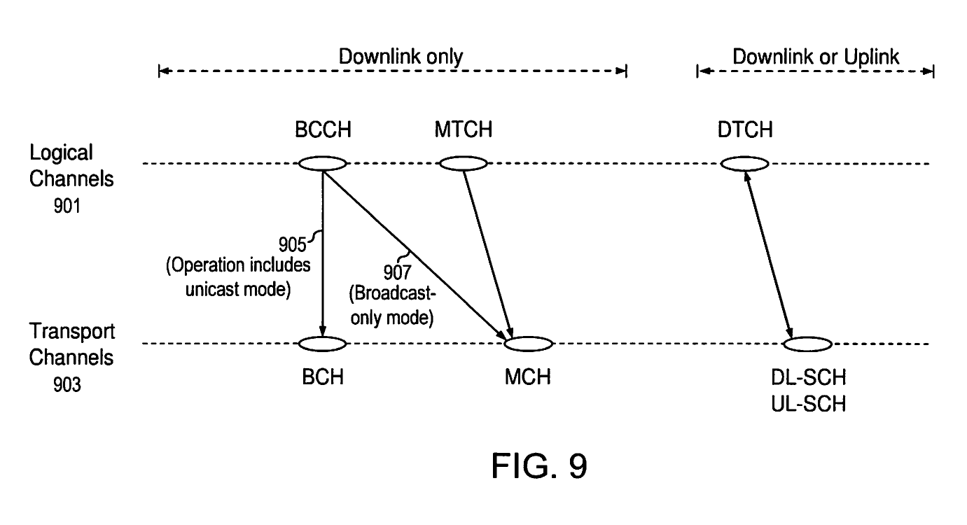

This aspect is further illustrated in FIG. 9, which shows exemplary mappings of logical channels 901 to physical channels 903. With respect to the BCCH (logical channel), mapping 905 is made to the BCH if the network's operation includes unicast operation. However, if the network is operating only in broadcast mode, mapping 907 of the BCCH is made to the MCH, so that dissemination of system information can take advantage of the SFN gain.

Referring back to FIG. 8, the UE needs to be able to detect whether the BCCH is mapped to the BCH or to the MCH. Therefore, in this exemplary embodiment, the network node 800 transmits an indicator that indicates to which physical channel (i.e., BCH or MCH) the logical BCCH is mapped (step 807). Exemplary embodiments this indicator are described in detail below.

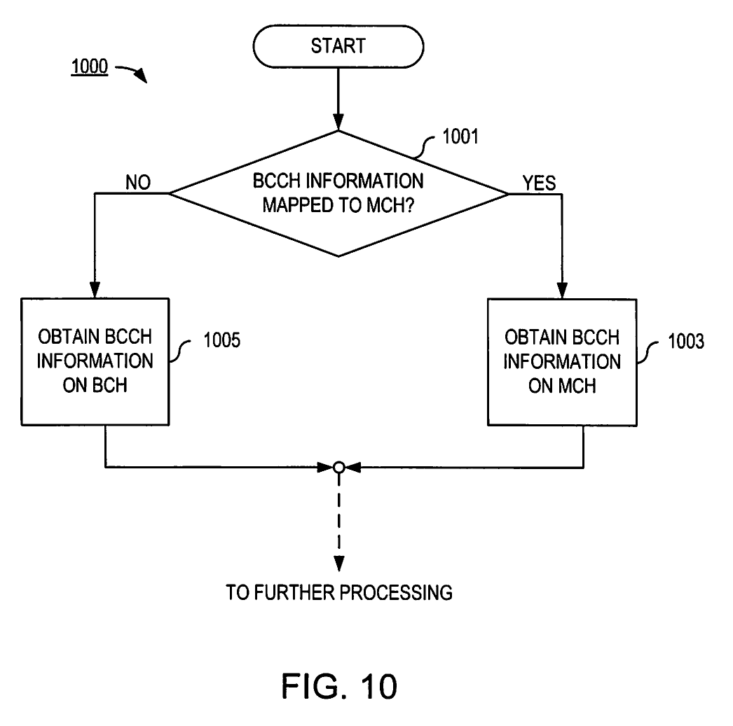

Focusing now on operation within a UE, it is necessary to first detect whether the BCCH is mapped to the BCH or to the MCH so that the UE will know how to receive the system information. FIG. 10 is a flowchart depicting this operation. FIG. 10 can also be considered to depict logic within a UE 1000 configured to perform the variously illustrated functions.

Logic in the UE determines whether the network (e.g., cell) has mapped the BCCH information to the MCH (decision block 1001). If so (“YES” path out of decision block 1001), the UE will obtain the BCCH information from the MCH (step 1003).

If the BCCH information is not mapped to the MCH (“NO” path out of decision block 1001), the UE will obtain the BCCH information from the BCH (step 1005).

The indication of how the BCCH is mapped (i.e., whether the mapping is to the MCH or to the BCH) can be communicated in various ways. It is particularly useful to communicate this indication in the signals that are used for the cell search procedure. Using the LTE system configuration and terminology as a non-limiting example, one way of doing this is to extend the number of primary synchronization signals beyond those that have already been defined. As described earlier, LTE systems support three different sequences for the primary synchronization signal. Adding, for example, a fourth sequence allows three of the sequences (e.g., call them sequences 1-3) to indicate that the “BCCH is mapped to the BCH”. A fourth sequence (call it sequence 4) is, in this exemplary embodiment, used to indicate that the “BCCH is mapped to the MCH”. Depending on the final sequences used in an LTE system, the addition of a fourth sequence may come at no additional cost.

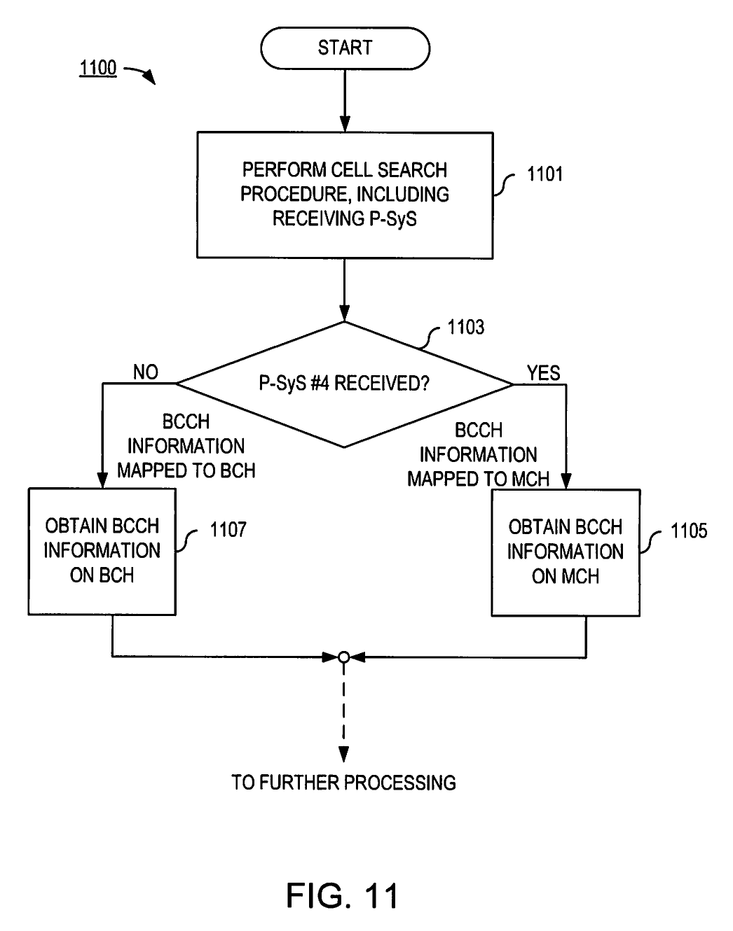

Suitable logic in a UE 1100 then performs functions illustrated in the flowchart of FIG. 11. FIG. 11 can also be considered to depict logic within a UE 1100 configured to perform the variously illustrated functions.

Logic in the UE 1100 performs a cell search procedure which, as described earlier, includes receiving a Primary Synchronization Signal (P-SyS) (step 1101). The UE's logic determines whether the Primary Synchronization Signal conveyed sequence #4 (decision block 1103). If so (“YES” path out of decision block 1103), this is an indication that the network (e.g., cell) has mapped the BCCH information to the MCH. Consequently, the UE 1100 will obtain the BCCH information from the MCH (step 1105).

If the Primary Synchronization Signal did not convey sequence #4 (i.e., the Primary Synchronization Signal conveyed one of the sequences #1, 2, or 3) (“NO” path out of decision block 1103), this is an indication that the network (e.g., cell) has mapped the BCCH information to the BCH. Consequently, the logic in the UE 1100 will obtain the BCCH information from the BCH (step 1107).

It will be understood that FIG. 11′s depiction of decision block 1103 as occurring after the entire cell search procedure has been performed (step 1101) is merely for the sake of convenience. In other embodiments, the test represented by decision block 1103 can be performed at any time after the Primary Synchronization Signal has been obtained, regardless of whether the cell search procedure has been completely performed.

In an alternative embodiment, another way of communicating an indication regarding the BCCH mapping in the signals that are used for the cell search procedure is to convey it as part of the Secondary Synchronization Sequence. This can be achieved by, for example, increasing the number of cell identity groups beyond the 168 that are presently specified for LTE systems. In such embodiments, sequences with numbers above 168 would indicate that the “BCCH is mapped on the MCH”, while the remaining sequences would indicate that the “BCCH is mapped on the BCH”.

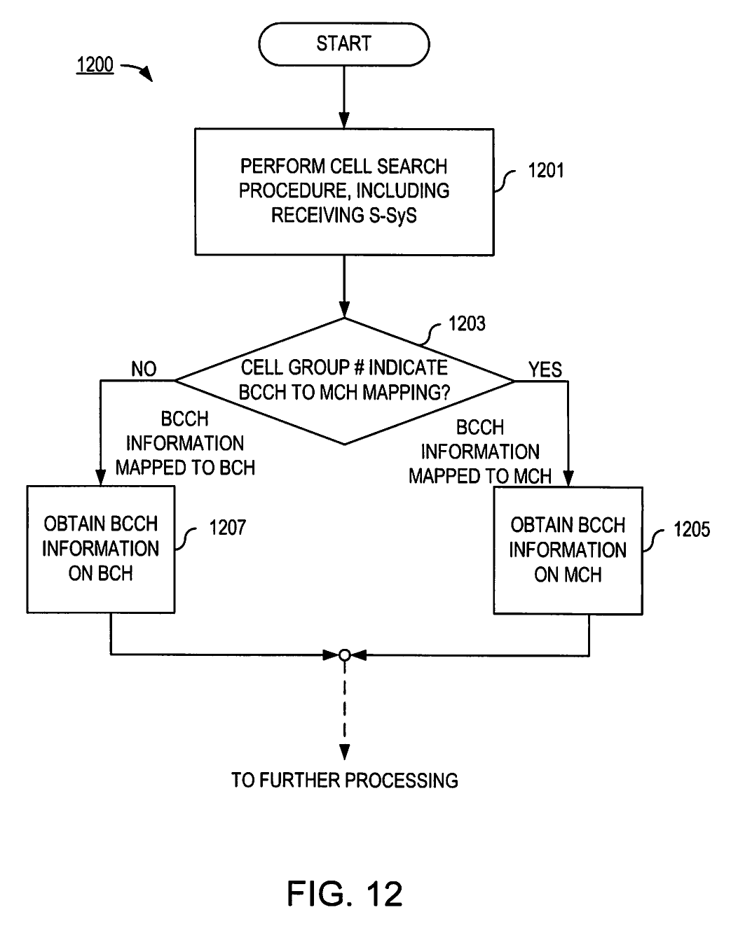

To carry out this embodiment, suitable logic in a UE 1200 performs functions illustrated in the flowchart of FIG. 12. FIG. 12 can also be considered to depict logic within a UE 1200 configured to perform the variously illustrated functions.

Logic in the UE 1200 performs a cell search procedure which, as described earlier, includes receiving a Secondary Synchronization Signal (S-SyS) (step 1201). The UE's logic determines whether the Secondary Synchronization Signal indicated a cell group ID associated with BCCH to MCH mapping (decision block 1203). If so (“YES” path out of decision block 1203), the UE 1200 will obtain the BCCH information from the MCH (step 1205).

If the Secondary Synchronization Signal did not indicate a cell group ID associated with BCCH to MCH mapping (“NO” path out of decision block 1203), the logic in the UE 1200 will obtain the BCCH information from the BCH (step 1207).

It will be understood that FIG. 12's depiction of decision block 1203 as occurring after the entire cell search procedure has been performed (step 1201) is merely for the sake of convenience. In other embodiments, the test represented by decision block 1203 can be performed at any time after the cell group ID has been determined from the Secondary Synchronization Signal, regardless of whether the cell search procedure has been completely performed.

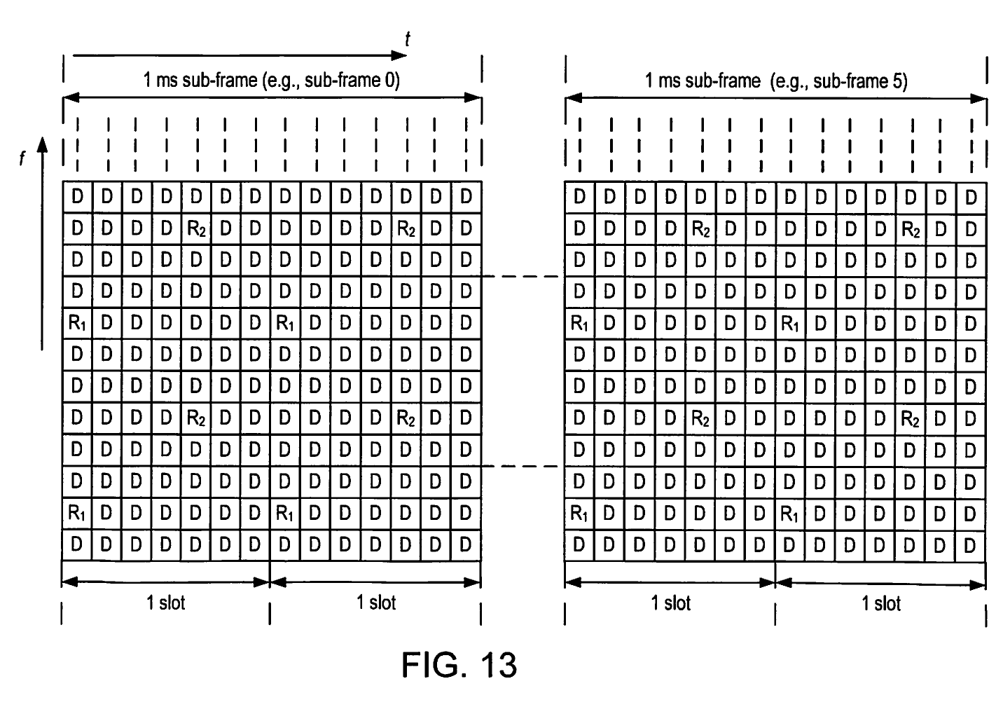

In yet another alternative embodiment, reference signal patterns that can be used for the cell search procedure are also used for communicating an indication regarding the BCCH mapping. As mentioned earlier, within each resource block there is a particular set of resource elements, known as reference symbols, set to known values. These are illustrated in FIG. 13 for the case in which there is a single transmit antenna at the base station. (When the base station includes more than one transmit antenna, the number of transmitted reference signals is greater than the number depicted in FIG. 13.) Reference symbols can be used by, for example, the UE to estimate the downlink channel for coherent detection. The reference symbols are also used as part of the LTE mobility function as described earlier.

As can be seen in FIG. 13, within each resource block there are four reference symbols, two reference symbols within the first OFDM symbol (denoted R₁) and two reference symbols in the third from last OFDM symbols (denoted R₂). Within the pair of resource blocks corresponding to one sub-frame there are thus a total of eight reference symbols, four reference symbols in the first resource block corresponding to the first slot of the sub-frame and four reference symbols in the second resource block corresponding to the second slot of the sub-frame.

Reference symbols are used in the downlink of LTE-systems for demodulation of unicast data and control signalling as well as for measurement purposes. These reference symbols are typically different for neighbour cells (i.e., they are cell specific). However, when an LTE radio access network includes MBSFN transmissions, additional reference symbols are transmitted in sub-frames with MBSFN transmission (i.e., in MBSFN sub-frames). These reference symbols, which can be referred to as MBSFN reference symbols, are identical for all cells involved in the MBSFN transmission (i.e., cell-common). By using the MBSFN reference symbols, the UE can estimate the aggregated channel from all cells involved in the MBSFN transmission. This channel estimate can be used for coherent detection of the combined MBSFN transmission.

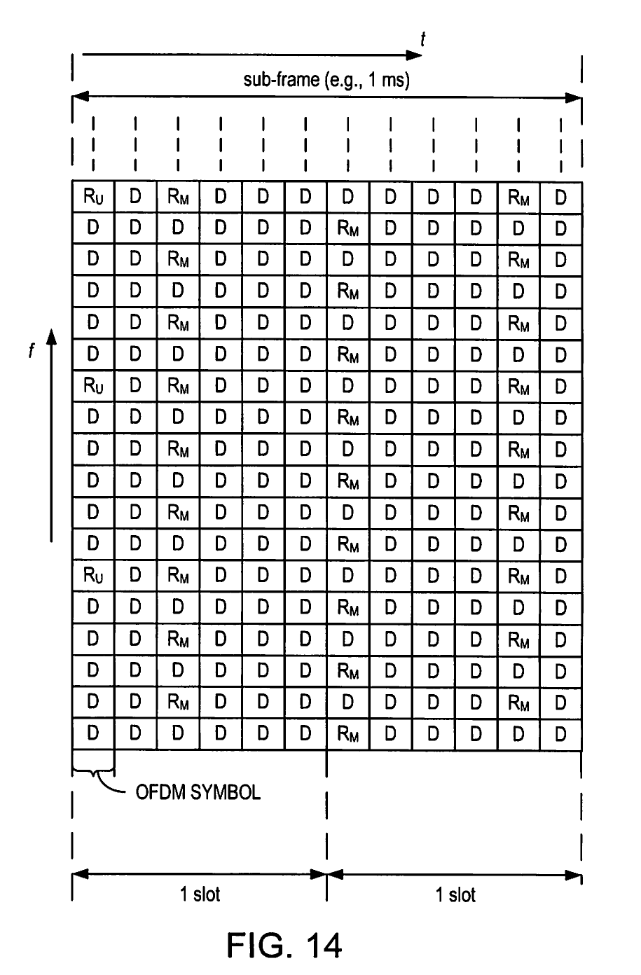

FIG. 14 illustrates the overall structure of MBSFN sub-frames in LTE, including the overall reference symbol structure for the mixed case in which both MBSFN subframes and unicast subframes are transmitted. In this illustration, MBSFN reference symbols are denoted “R_{M}”, and unicast reference symbols are denoted “R_{U}”. In order to minimize the reference symbol overhead, in MBSFN sub-frames unicast references symbols are only transmitted in the first OFDM symbol of the first slot of the sub-frame (an “MBSFN group of OFDM symbols”). Recalling that non-MBSFN sub-frames comprise first and second reference symbols per slot in each of the first and second slots of the sub-frame, it can be seen that the number of unicast reference symbols transmitted in MBSFN sub-frames has been reduced.

In the case of a dedicated MBSFN carrier (i.e., the case in which there are no unicast transmissions), there is no need for the unicast reference symbols (R_{U}) to be transmitted at all.

In order to use reference signals as an indicator of whether the BCCH is mapped to the BCH or to the MCH, certain reference signal patterns can be reserved to indicate one or the other. It is noted, however, that this would require that the unicast reference signals be transmitted in SFN operation, which is less desirable since the MBSFN reference signals are needed regardless. Alternatively, the receiver could detect whether unicast or MBSFN reference signals are transmitted by, for example, exploiting the correlation properties of the reference signal sequences, and using this as a basis for determining the corresponding method for transmission of system information.

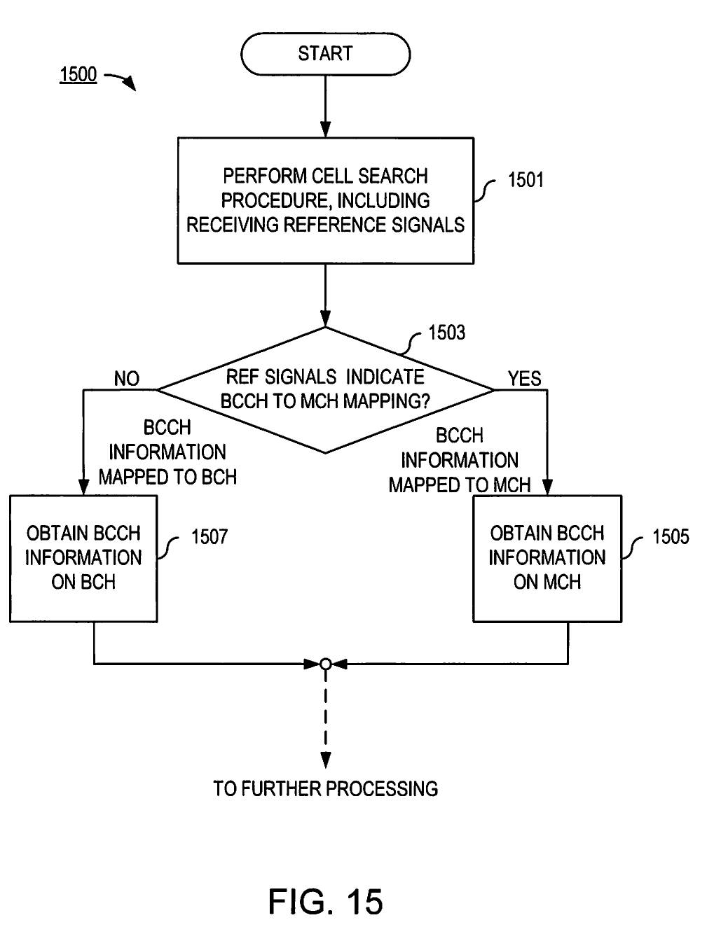

To carry out this embodiment, suitable logic in a UE 1500 performs functions illustrated in the flowchart of FIG. 15. FIG. 15 can also be considered to depict logic within a UE 1500 configured to perform the variously illustrated functions.

Logic in the UE 1500 performs a cell search procedure which, as described earlier, includes receiving reference signals (step 1501). The UE's logic determines whether the reference signals indicate that the BCCH is mapped to the MCH (decision block 1503). If so (“YES” path out of decision block 1503), the UE 1500 will obtain the BCCH information from the MCH (step 1505).

If the reference signals did not indicate that the BCCH is mapped to the MCH (“NO” path out of decision block 1503), the logic in the UE 1500 will obtain the BCCH information from the BCH (step 1507).

It will be understood that FIG. 15′s depiction of decision block 1503 as occurring after the entire cell search procedure has been performed (step 1501) is merely for the sake of convenience. In other embodiments, the test represented by decision block 1503 can be performed at any time after the reference signals have been received, regardless of whether every aspect of the cell search procedure has been completely performed.

Several exemplary embodiments have been described, illustrating how the signals involved in the cell search procedure can be utilized to convey an indication of how the BCCH information is mapped. It will be appreciated that these are only examples, and that it is envisioned that other techniques for doing this can be used as well.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

1. A method of operating a User Equipment (UE) in a cellular communication system that includes a network node, the method comprising:
receiving, from the network node, an indicator that indicates whether broadcast channel information is conveyed via a physical unicast transmission resource or a physical multicast/broadcast transmission resource;
ascertaining whether broadcast channel information is conveyed via the physical unicast transmission resource or the physical multicast/broadcast transmission resource;
receiving the broadcast channel information from the physical unicast transmission resource if the indicator indicates that the broadcast channel information is conveyed via the physical unicast transmission resource; and
receiving the broadcast channel information from the physical multicast/broadcast transmission resource if the indicator indicates that the broadcast channel information is conveyed via the physical multicast/broadcast transmission resource.

2. The method of claim 1, wherein:
the physical unicast transmission resource is a physical broadcast channel; and
the physical multicast/broadcast transmission resource is a physical multicast/broadcast channel.

3. The method of claim 1, wherein the indicator is a signal communicated to the UE from the network node at one or more predetermined locations within a radio frame for communicating at least one of timing and other information to the UE.

4. The method of claim 1, wherein:
the indicator is a Primary Synchronization Signal that enables the UE to determine a first timing parameter of signals received from the network node, the Primary Synchronization Signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

5. The method of claim 1, wherein
the indicator is a Secondary Synchronization Signal that enables the UE to determine a second timing parameter of signals received from the network node, the Secondary Synchronization Signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

6. The method of claim 5, wherein the at least one of the different sequences further indicates cell group information.

7. The method of claim 1, wherein
the indicator is a reference signal that enables the UE to determine cell specific information from the network node, the reference signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

8. A method of operating a network node in a mobile communication system that serves a User Equipment (UE), the method comprising:
ascertaining whether the network node is operating in a broadcast-only mode;
if the network node is operating in the broadcast-only mode, then transmitting broadcast channel information on a physical multicast/broadcast transmission resource; and
if the network node is not operating in the broadcast-only mode, then transmitting the broadcast channel information on a physical unicast transmission resource.

9. The method of claim 8, wherein:
the physical unicast transmission resource is a physical broadcast channel; and
the physical multicast/broadcast transmission resource is a multicast/broadcast channel.

10. The method of claim 8, comprising:
transmitting an indicator to the UE, wherein the indicator indicates whether the broadcast channel information is conveyed via the physical unicast transmission resource or the physical multicast/broadcast transmission resource.

11. The method of claim 10, wherein the indicator is a signal communicated to the UE from the network node at one or more predetermined locations within a radio frame for communicating at least one of timing and other information to the UE.

12. The method of claim 10, wherein:
the indicator is a Primary Synchronization Signal that enables the UE to determine a first timing parameter of signals received from the network node, the Primary Synchronization Signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

13. The method of claim 10, wherein
the indicator is a Secondary Synchronization Signal that enables the UE to determine a second timing parameter of signals received from the network node, the Secondary Synchronization Signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

14. The method of claim 13, wherein the at least one of the different sequences further indicates cell group information.

15. The method of claim 10, wherein
the indicator is a reference signal that enables the UE to determine cell specific information from the network node, the reference signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

16. An apparatus for operating a User Equipment (UE) in a cellular communication system that includes a network node, the apparatus comprising:
logic configured to receive, from the network node, an indicator that indicates whether broadcast channel information is conveyed via a physical unicast transmission resource or a physical multicast/broadcast transmission resource;
logic configured to ascertain whether broadcast channel information is conveyed via the physical unicast transmission resource or the physical multicast/broadcast transmission resource;
logic configured to receive the broadcast channel information from the physical unicast transmission resource if the indicator indicates that the broadcast channel information is conveyed via the physical unicast transmission resource; and
logic configured to receive the broadcast channel information from the physical multicast/broadcast transmission resource if the indicator indicates that the broadcast channel information is conveyed via the physical multicast/broadcast transmission resource.

17. The apparatus of claim 16, wherein:
the physical unicast transmission resource is a physical broadcast channel; and
the physical multicast/broadcast transmission resource is a physical multicast/broadcast channel.

18. The apparatus of claim 16, wherein the indicator is a signal communicated to the UE from the network node at one or more predetermined locations within a radio frame for communicating at least one of timing and other information to the UE.

19. The apparatus of claim 16, wherein:
the indicator is a Primary Synchronization Signal that enables the UE to determine a first timing parameter of signals received from the network node, the Primary Synchronization Signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

20. The apparatus of claim 16, wherein
the indicator is a Secondary Synchronization Signal that enables the UE to determine a second timing parameter of signals received from the network node, the Secondary Synchronization Signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

21. The apparatus of claim 20, wherein the at least one of the different sequences further indicates cell group information.

22. The apparatus of claim 16, wherein
the indicator is a reference signal that enables the UE to determine cell specific information from the network node, the reference signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

23. An apparatus for operating a network node in a mobile communication system that serves a User Equipment (UE), the apparatus comprising:
logic configured to ascertain whether the network node is operating in a broadcast-only mode;
logic configured to transmit broadcast channel information on a physical multicast/broadcast transmission resource if the network node is operating in the broadcast-only mode; and
logic configured to transmit the broadcast channel information on a physical unicast transmission resource if the network node is not operating in the broadcast-only mode.

24. The apparatus of claim 23, wherein:
the physical unicast transmission resource is a physical broadcast channel; and
the physical multicast/broadcast transmission resource is a physical multicast/broadcast channel.

25. The apparatus of claim 23, comprising:
logic configured to transmit an indicator to the UE, wherein the indicator indicates whether the broadcast channel information is conveyed via the physical unicast transmission resource or the physical multicast/broadcast transmission resource.

26. The apparatus of claim 25, wherein the indicator is a signal communicated to the UE from the network node at one or more predetermined locations within a radio frame for communicating at least one of timing and other information to the UE.

27. The apparatus of claim 25, wherein:
the indicator is a Primary Synchronization Signal that enables the UE to determine a first timing parameter of signals received from the network node, the Primary Synchronization Signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

28. The apparatus of claim 25, wherein
the indicator is a Secondary Synchronization Signal that enables the UE to determine a second timing parameter of signals received from the network node, the Secondary Synchronization Signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.

29. The apparatus of claim 28, wherein the at least one of the different sequences further indicates cell group information.

30. The apparatus of claim 25, wherein
the indicator is a reference signal that enables the UE to determine cell specific information from the network node, the reference signal additionally conveying one of a plurality of different sequences, wherein at least one of the different sequences indicates that the broadcast channel information is conveyed via the physical unicast transmission resource, and at least another one of the different sequences indicates that the broadcast channel information is conveyed via the physical multicast/broadcast transmission resource.
